(19) United States
(12) Patent Application Publication
(10) Pub. No.: US 2015/0367957 A1
(43) Pub. Date: Dec. 24, 2015

(54) PROVIDING VISIBILITY TO A VEHICLE'S ENVIRONMENT VIA A SET OF CAMERAS WHICH IS CONFORMAL TO THE VEHICLE

(71) Applicant: AAI Corporation, Hunt Valley, MD (US)

(72) Inventors: Richard C. Uskert, Monkton, MD (US); R. Michael Guterres, Reisterstown, MD (US); Jason Wallace, Waltham, MA (US); Matthew T. Velazquez, Owings Mills, MD (US)

(21) Appl. No.: 14/308,236

(22) Filed: Jun. 18, 2014

(51) Int. Cl. B64D 47/08; H04N 5/247; H04N 7/18; H04N 5/232

(52) U.S. Cl. CPC B64D 47/08; H04N 5/23238; H04N 5/247; H04N 7/181

(57) ABSTRACT

An aircraft camera system provides visibility to a vehicle's environment. The vehicle has a set of vehicle surface portions (e.g., aircraft sections, panels, surfaces, combinations thereof, etc.) which defines a shape of the vehicle. The aircraft camera system includes a set of cameras integrated with the set of vehicle surface portions to avoid adding fluid drag force on the vehicle as the vehicle moves within the vehicle's environment. The aircraft camera system further includes a controller coupled to the set of cameras. The controller is constructed and arranged to obtain a set of camera signals from the set of cameras and output a set of electronic signals based on the set of camera signals. The set of electronic signals provides a set of images of the vehicle's environment from a perspective of the vehicle.

### BACKGROUND

It is possible to capture images of a target (an object or a scene) from the air. One conventional approach to capturing images of a target from the air is for a human to manually hold and operate a camera while the human is aboard an aircraft. That is, the human physically aims the camera and snaps images of the target.

Another conventional approach to obtaining images of a target from the air involves mounting a camera to an aircraft using a gimbal. A gimbal is a specialized device which attaches the camera to the aircraft and which enables the camera to pivot relative to the aircraft (perhaps about multiple axes) in order to precisely aim the camera at the target while the aircraft is in flight.

### SUMMARY

Unfortunately, there are deficiencies to the above-described conventional approaches to capturing images from the air. Along these lines, the above-described conventional manual approach which requires a human to be aboard an aircraft and to manually hold a camera may be inappropriate for certain situations. For example, in the context of small aircraft, it may be burdensome and/or distracting for a human to physically aim and operate the camera if the human is also the pilot.

Additionally, in connection with the above-described conventional gimbal approach, there are drawbacks to using gimbals. In particular, gimbaled cameras place drag on aircraft while the aircraft are in flight. Furthermore, the servo mechanisms of gimbals can be difficult to operate and may be prone to failure (e.g., gimbals may inaccurately aim cameras, gimbals may freeze or become stuck in place, etc.).

One possible alternative to using a gimbal to mount a camera to an aircraft is to attach a modern panoramic camera device to the aircraft. Such a modern panoramic camera device may have a compact structure (e.g., the device may be block-shaped, ball-shaped, etc.) and may include multiple cameras aimed in various directions. However, even the use of such a modern panoramic camera device still imposes drawbacks. For example, when such modern panoramic camera devices are mounted to aircraft, such devices may still provide significant drag on the aircraft in the same manner as conventional gimbaled cameras. Moreover, even though a modern panoramic camera device may advertise an ability to obtain a maximum field of view, the aircraft to which that device would mount would produce a blind spot (i.e., it is impossible for the camera device to capture an image of the other side of the aircraft) thus limiting the ability of that device to capture a relatively wide field of view.

In contrast to the above-described conventional approaches to capturing images from the air, improved techniques are directed to providing visibility to a vehicle's environment via a set of cameras which is conformal to the vehicle. That is, the vehicle includes a set of vehicle surface portions which defines the shape of the vehicle. For example, a fixed-wing aircraft can be formed of fuselage sections, wing sections, a nose section, a tail section, and so on. In such situations, a set of cameras is integrated with the set of vehicle surface portions to avoid causing drag (e.g., each camera is substantially embedded within a respective surface portion of the vehicle). A controller which is coupled to the set of cameras then processes individual camera signals from the cameras and outputs a set of electronic signals providing a set of images of the vehicle's environment from a perspective of the vehicle. In some arrangements, the controller provides a full 360 degree view of the environment around the vehicle. Accordingly, no human camera aiming or gimbals are required.

One embodiment is directed to an aircraft camera system which provides visibility to a vehicle's environment. The vehicle has a set of vehicle surface portions (e.g., aircraft sections, panels, surfaces, combinations thereof, etc.) which defines a shape of the vehicle. The aircraft camera system includes a set of cameras integrated with the set of vehicle surface portions to avoid adding fluid drag force on the vehicle as the vehicle moves within the vehicle's environment. The aircraft camera system further includes a controller coupled to the set of cameras. The controller is constructed and arranged to obtain a set of camera signals from the set of cameras and output a set of electronic signals based on the set of camera signals. The set of electronic signals provides a set of images of the vehicle's environment from a perspective of the vehicle.

In some arrangements, the set of cameras includes multiple fixed cameras. Each fixed camera has a fixed viewing direction to capture an image of the vehicle's environment at a predefined angle from the vehicle.

In some arrangements, the vehicle is an unmanned aerial vehicle (UAV). In these arrangements, the set of vehicle surface portions defines a shape of the UAV. Here, each fixed camera resides at or below the surface of a respective vehicle surface portion of the set of vehicle surface portions. Accordingly, there is no significant drag causes by the cameras.

In some arrangements, each fixed camera aims in a different direction to capture an image of the vehicle's environment at a different angle from the vehicle. Accordingly, the set of electronic signals outputted by the controller can define a multi-directional composite view of the vehicle's environment. For example, the multi-directional composite view of the vehicle's environment may be a full 360 degree view from the perspective of the vehicle.

In some arrangements, the controller is constructed and arranged to perform a set of image knitting operations to generate the full 360 degree view from the perspective of the vehicle. That is, the controller is able to construct a complete spherical view of the entire environment of the vehicle.

It should be understood that various types of sensing mechanisms can be employed by the cameras. In some arrangements, the full 360 degree view from the perspective of the vehicle includes a set of visual light images. In some arrangements, the full 360 degree view from the perspective of the vehicle includes a set of infrared images. In some arrangements, the full 360 degree view from the perspective of the vehicle includes a set of laser-detected and ranging (LiDAR) images, and so on. In some arrangements, the full 360 degree view from the perspective of the vehicle includes (i) a set of visual light images, (ii) a set of infrared images, and (iii) a set of LiDAR images.

In some arrangements, the vehicle is an unmanned aerial vehicle (UAV), and the set of vehicle surface portions includes a UAV nose section. In these arrangements, the multiple fixed cameras include a nose section camera which is integrated with the UAV nose section. Accordingly, there is little or no drag provided by the nose section camera.

In some arrangements, the set of vehicle surface portions further includes a UAV tail section. In these arrangements, the multiple fixed cameras further include a tail section camera which is integrated with the UAV tail section. Accordingly, there is little or no drag provided by the tail section camera.

In some arrangements, the set of vehicle surface portions further includes a UAV belly section. In these arrangements, the multiple fixed cameras further include a belly section camera which is integrated with the UAV belly section. Accordingly, there is little or no drag provided by the belly section camera.

In some arrangements, the set of vehicle surface portions further includes a UAV right wing section and a UAV left wing section. In these arrangements, the multiple fixed cameras further include a right wing section camera which is integrated with the UAV right wing section and a left wing section camera which is integrated with the UAV left wing section. Accordingly, there is little or no drag provided by the wing section cameras.

Another embodiment is directed to an unmanned aerial vehicle (UAV). The UAV includes a set of UAV surface portions which defines a shape of the UAV, a set of cameras integrated with the set of UAV surface portions to avoid adding fluid drag force on the UAV as the UAV moves within an environment, and a controller coupled to the set of cameras. The controller is constructed and arranged to obtain a set of camera signals from the set of cameras and output a set of electronic signals based on the set of camera signals. The set of electronic signals provides images of the environment from a perspective of the UAV.

Yet another embodiment is directed to a method of providing visibility to a vehicle's environment. The method includes deploying, into the environment, a UAV having (i) a set of UAV surface portions which defines a shape of the UAV, (ii) a set of cameras integrated with the set of UAV surface portions to avoid adding fluid drag force on the UAV as the UAV moves within an environment, and (iii) a controller coupled to the set of cameras. The controller is constructed and arranged to obtain a set of camera signals from the set of cameras and output a set of electronic signals based on the set of camera signals. The set of electronic signals provides images of the environment from a perspective of the UAV. The method further includes obtaining the set of electronic signals from the UAV and, after the set of electronic signals have been obtained, using the set of electronic signals from the UAV to display the images of the environment from the perspective of the UAV.

Other embodiments are directed to electronic systems and apparatus, processing circuits, computer program products, and so on. Some embodiments are directed to various methods, electronic components and circuitry which are involved in providing visibility to a vehicle's environment.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of a vehicle which is equipped with a camera system having a set of cameras which is conformal to the vehicle.

FIG. 2 is a block diagram of particular components of the camera system of FIG. 1.

FIG. 3 is a perspective view of a vehicle portion having an integrated fixed camera of the camera system of FIG. 1.

FIG. 4 is a cross-sectional diagram illustrating how a fixed camera of the camera system of FIG. 1 is integrated with a portion of the vehicle to prevent causing drag while the vehicle is moving.

FIG. 5 is a pictorial diagram of a particular aspect of a set of images provided by the camera system of FIG. 1.

FIG. 6 is a flowchart of a procedure which is performed by the camera system of FIG. 1.

FIG. 7 is a perspective view of an alternative vehicle to that of FIG. 1.

FIG. 8 is a block diagram of particular components of the camera system in an alternative arrangement to that of FIG. 2.

### DETAILED DESCRIPTION

An improved technique is directed to providing visibility to a vehicle's environment via a set of cameras which is conformal to the vehicle. In particular, the vehicle includes a set of vehicle surface portions which defines the shape of the vehicle. For example, a fixed-wing aircraft can be formed of one or more fuselage sections, wing sections, a nose section, a tail section, and so on. In such situations, a set of cameras is integrated with the set of vehicle surface portions to avoid causing fluid drag force on the vehicle (e.g., each camera is substantially embedded within a respective surface portion of the vehicle). A controller which is coupled to the set of cameras then processes individual camera signals from the cameras and outputs a set of electronic signals providing a set of images of the vehicle's environment from a perspective of the vehicle. In some arrangements, the controller provides a full 360 degree view of the environment around the vehicle. Accordingly, a human does not need to aim the camera and no gimbal is required.

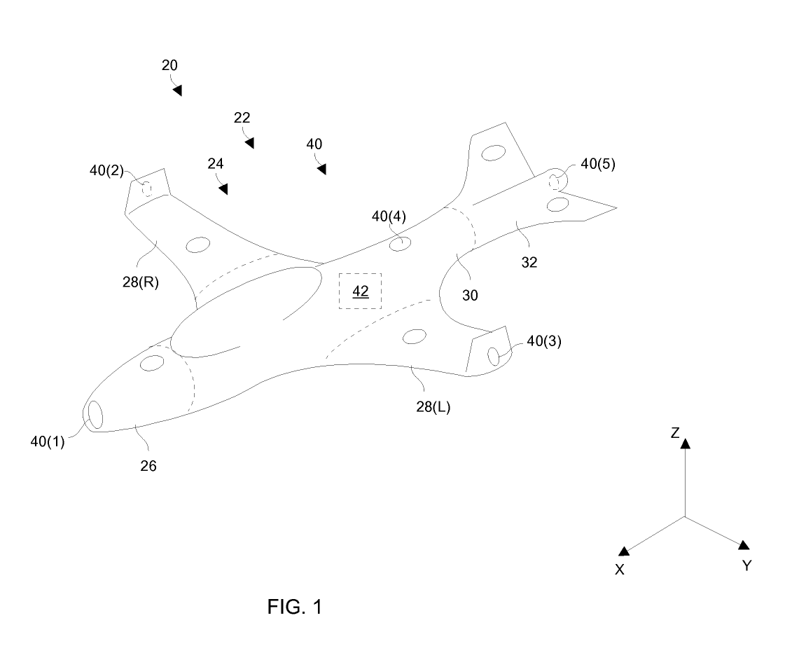

FIG. 1 shows a vehicle 20 which is equipped with a camera system 22 which provides visibility to the vehicle's environment via a set of cameras which is conformal to the vehicle 20. With such a camera system 22, a multi-directional composite view of the vehicle's environment can be generated without any blind spots.

The vehicle 20 includes multiple vehicle portions 24 which defines a shape and surface of the vehicle 20. By way of example, the vehicle 20 shown as an unmanned aerial vehicle (UAV) having, as at least some of the vehicle portions 24, a nose section 26, a right wing section 28(R), a left wing section 28(L), a fuselage section 30, a tail section 32, and so on. It should be understood that such portions 24 can be formed by a housing, skin or panels attached to a frame or supporting structure (e.g., for larger vehicles 20). Alternatively, such portions 24 can be formed by individual units or segments that attach together to substantially form the body of the vehicle 20 (e.g., for smaller or miniature vehicles 20). Other techniques are suitable for use as well.

The camera system 22 includes a set of cameras 40(1), 40(2), 40(3), 40(4), 40(5), . . . (collectively, cameras 40) and a controller 42. The set of cameras 40 is conformal to the vehicle 20. That is, each camera 40 resides at or just below the vehicle's surface (e.g., flush, under the surface, etc.) so as not to create drag when the vehicle 20 is moving. The controller 42 of the camera system 22 is constructed and arranged to receive a set of camera signals from the set of cameras 40 and output a set of electronic signals based on the set of camera signals. As will be described in further detail shortly, the set of electronic signals provides a set of images of the vehicle's environment from a perspective of the vehicle 20.

In the UAV example of FIG. 1, the camera 40(1) is integrated with the nose section 26, the camera 40(2) is integrated into the right wing section 28(R), the camera 40(3) is integrated into the left wing section 28(L), the camera 40(4) is integrated with the fuselage section 30, the camera 40(5) is integrated in the tail section 32, and so on. It should be understood that some portions 24 of the vehicle 20 may include multiple cameras 40 (e.g., see the nose section 26), and other portions 24 of the vehicle 20 may include no cameras 40. In some arrangements, the cameras 40 are fixed cameras with little or no moving parts to alleviate dependence on electro-mechanics and thus improve reliability.

It should be understood that the cameras 40 aim in predefined different directions. For example, the camera 40(1) aims in the positive X-direction, the camera 40(2) aims in the negative Y-direction, the camera 40(3) aims in the positive Y-direction, the camera 40(4) aims in the positive Z-direction, the camera 40(5) aims in the negative X-direction, and so on. Other cameras can aim in other directions too such as in the negative Z-direction, etc. In some arrangements, the cameras 40 collectively provide full 360 degree coverage. In other arrangements, the cameras 40 provide less than 360 degree coverage (e.g., 270 degrees of coverage).

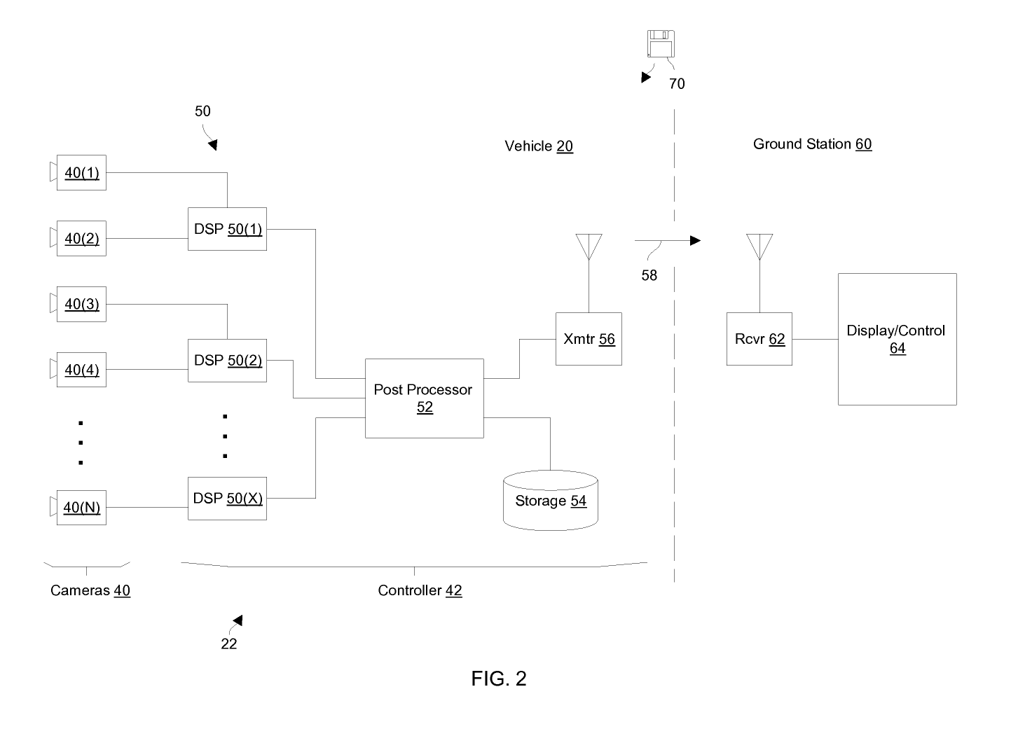

In some arrangements, the cameras 40 provide redundancy and/or 3D capabilities (e.g., multiple displaced cameras 40 aimed in the same direction). Further details will now be provided with reference to FIG. 2.

FIG. 2 is a block diagram of particular components of the camera system 22. The set of cameras 40 may include a large number of fixed cameras (i.e., cameras that do not require aiming and sense an entire field of view through a lens). Along these lines, the number of cameras N may be 6 or greater (e.g., 8, 10, 12, more than 12, etc.). Moreover, as fixed cameras become smaller, lighter-weight, and less expensive, such fixed cameras can be distributed around a vehicle's body without significantly interfering with other vehicle subsystems and vehicle operation.

The controller 42 includes digital signal processing (DSP) circuitry 50 (e.g., DSP circuits 50(1), 50(2), . . . , 50(X)), a post processor 52, storage 54, and a transmitter 56. The DSP circuitry 50 processes data from individual camera signals from the cameras 40 to form individual images or frames. The post processor 52 knits or combines the data of the individual images together to form a composite image (e.g., a mosaic or panoramic view including data from multiple images), and outputs both the individual and knitted images (i.e., image data 58) to the storage 54 and to the transmitter 56. The storage 54 retains the image data 58 for later retrieval. The transmitter 56 relays the image data 58 to a ground station 60 (e.g., via wireless transmission such as shortwave radio, cellular, microwave, etc.).

A receiver 62 at the ground station 60 receives the image data 58 which can then be further processed and utilized by display/control circuitry 64. For example, the display/control circuitry 64 can analyze the data for surveillance purposes, military or defense purposes, topological purposes, research, exploration, training, and so on.

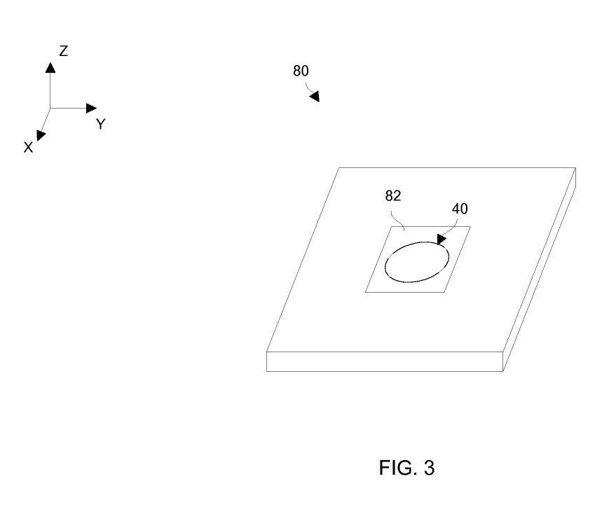

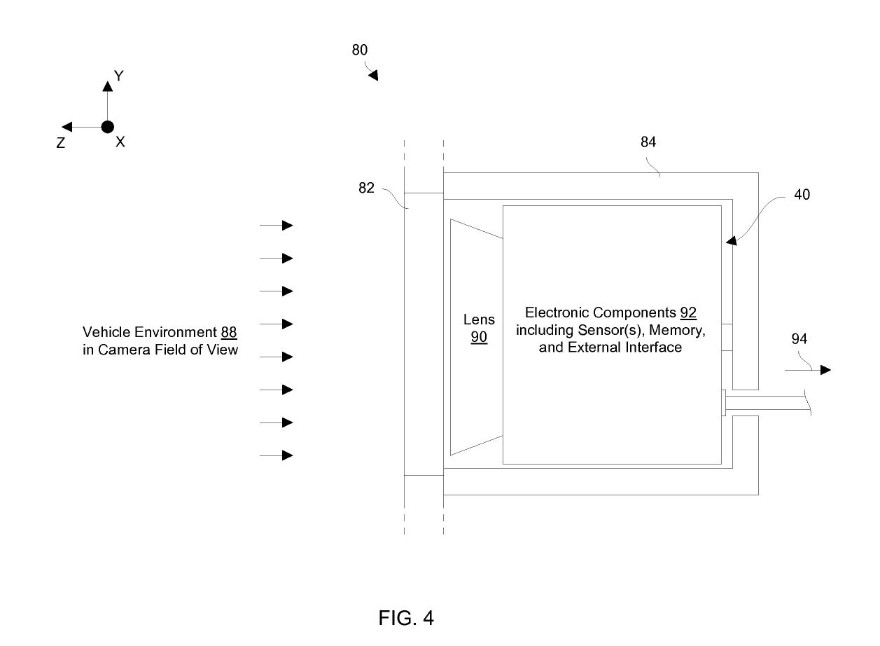

It should be understood that at least some of the circuitry described above can be formed by a set of processing circuits executing one or more software applications. Moreover, such circuitry may be implemented in a variety of ways including a combination of one or more processors (or cores) running specialized software, application specific ICs (ASICs), field programmable gate arrays (FPGAs) and associated programs, discrete components, analog circuits, other hardware circuitry, combinations thereof, and so on. In the context of one or more processors executing software, a computer program product 70 is capable of delivering all or portions of the software constructs to the circuitry. The computer program product 70 has a non-transitory (or non-volatile) computer readable medium which stores a set of instructions which controls one or more operations of the camera system 22. Examples of suitable computer readable storage media include tangible articles of manufacture and apparatus which store instructions in a non-volatile manner such as CD-ROM, flash memory, disk memory, tape memory, and the like. Further details will now be provided with reference to FIGS. 3 and 4.

FIGS. 3 and 4 illustrate suitable ways of integrating the cameras 40 to be conformal with the vehicle 20. FIG. 3 is a perspective view of a vehicle portion 24 having an integrated fixed camera of the camera system 22. FIG. 4 is a cross-sectional diagram illustrating how the fixed camera of the camera system 22 is integrated within the vehicle portion 24 to prevent causing drag while the vehicle 20 is moving.

As shown in FIG. 3, the vehicle portion 24 takes the form of a panel 80 which defines part of the vehicle surface (e.g., a portion of the wing, tail, or fuselage of an aircraft) and extends along the X-Y plane. The panel 80 assists in protecting the internal space of the vehicle 20 (e.g., the structural frame of the vehicle 20, circuitry within the vehicle 20, fuel tanks, etc.). At least some material 82 of the panel 80 is formed of transparent material (e.g., a clear plate) that enables a camera 40 of the camera system 22 to sense the vehicle's surroundings 88 (e.g., in the Z-direction). Suitable material includes clear plastic, plexiglass, and sapphire glass, among other materials.

As shown in FIG. 4, the panel 80 further includes a housing 84 which is constructed and arranged to support and house the camera 40 in a manner which enables the lens 90 and electronics 92 of the camera 40 to sense through the material 82. As a result, the camera 40 is able to provide a camera signal 94 containing one or more images of the vehicle environment 88 in the camera's field of view (e.g., in the Z-direction in FIG. 4).

In should be understood that the recessed location of the camera 40 prevents the camera 40 from creating drag when the vehicle 20 is in motion. Furthermore, the camera 40 is protected against unnecessary exposure to the environment 88, e.g., exposure to wind damage, collisions with particles, radiation, and so on. Other forms of camera integration are suitable as well such as surface mounting the camera 40 in a recess so that the top of the camera 40 is at or below the surface of the vehicle 20 (e.g., flush with the surface of the vehicle) rather than extending above the surface.

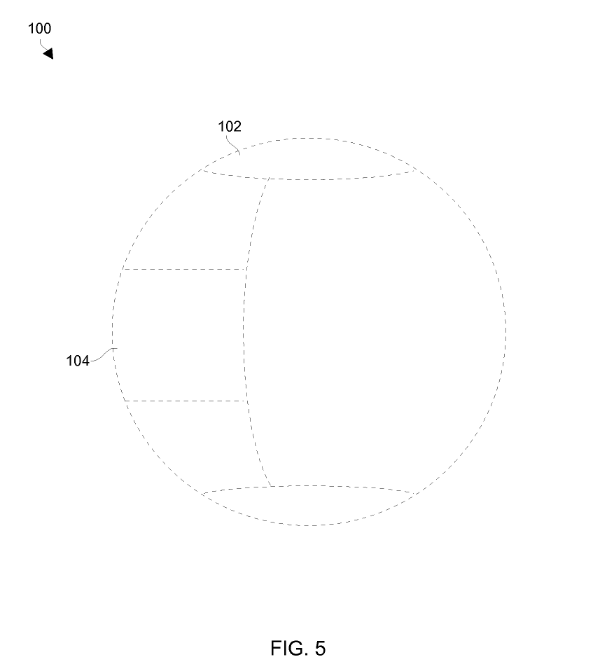

It should be further understood that the cameras 40 may be configured to sense visual light as well as other types of information. In some arrangements, the set of cameras 40 include infrared sensors to capture infrared images. In some arrangements, the set of cameras 40 include laser-detection and ranging (LiDAR) sensors to capture LiDAR images. In some arrangements, the set of cameras 40 includes visual light sensors, infrared sensors, and LiDAR sensors, perhaps among others. Further details will now be provided with reference to FIG. 5.

FIG. 5 is a pictorial diagram of a multi-directional composite view 100 of the vehicle's environment 88 which is provided by the controller 42 of the camera system 22 (also see FIG. 2). In particular, when the camera system 22 collects images that share a common boundary, the camera system 22 knits the images together to form a composite image from the images. For example, when the set of cameras 40 collects image data in all directions so that there are no blind spots, the controller 42 is constructed and arranged to knit that image data together to form a full 360 degree view (i.e., an image sphere) from the perspective of the vehicle 20.

Along these lines, various portions of the multi-directional composite view 100 are based on image data from particular cameras 40. For example, in the connection with the UAV example of FIG. 1, a top portion 102 of the image sphere may primarily include image data from the camera 40(4), a front portion 104 of the image sphere may primarily include image data from the camera 40(1), and so on. Such an image sphere may be useful for various purposes such as flight training, exploration, cinematic movies, exhibits, and so on. Moreover, such an image sphere can be processed into moving video (i.e., a series of images or frames) for special effects, etc.

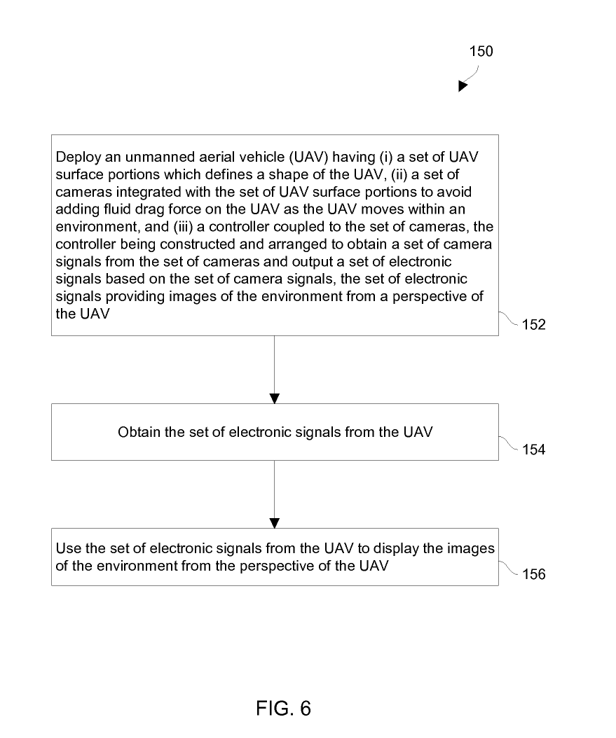

In some arrangements, the multi-directional composite view 100 includes visual light images. In some arrangements, the multi-directional composite view 100 includes infrared images. In some arrangements, the multi-directional composite view 100 includes LiDAR images, and so on. Further details will now be provided with reference to FIG. 6.

FIG. 6 is a flowchart of a procedure 150 which is performed by a team of humans using the camera system 22. At 152, the team of humans deploys a UAV having (i) a set of UAV surface portions which defines a shape of the UAV, (ii) a set of cameras integrated with the set of UAV surface portions to avoid adding fluid drag force on the UAV as the UAV moves within an environment, and (iii) a controller coupled to the set of cameras. The controller is constructed and arranged to obtain a set of camera signals from the set of cameras and output a set of electronic signals based on the set of camera signals (also see FIG. 2). The set of electronic signals provides images of the environment from a perspective of the UAV (also see FIG. 5).

At 154, the team of humans obtains the set of electronic signals from the UAV. For example, a ground control station 60 (FIG. 2) may receive transmitted image data 58 from the UAV while the UAV is in flight. Alternatively, the ground control station 60 may retrieve the image data 58 from storage 54 (FIG. 2) after the UAV has landed.

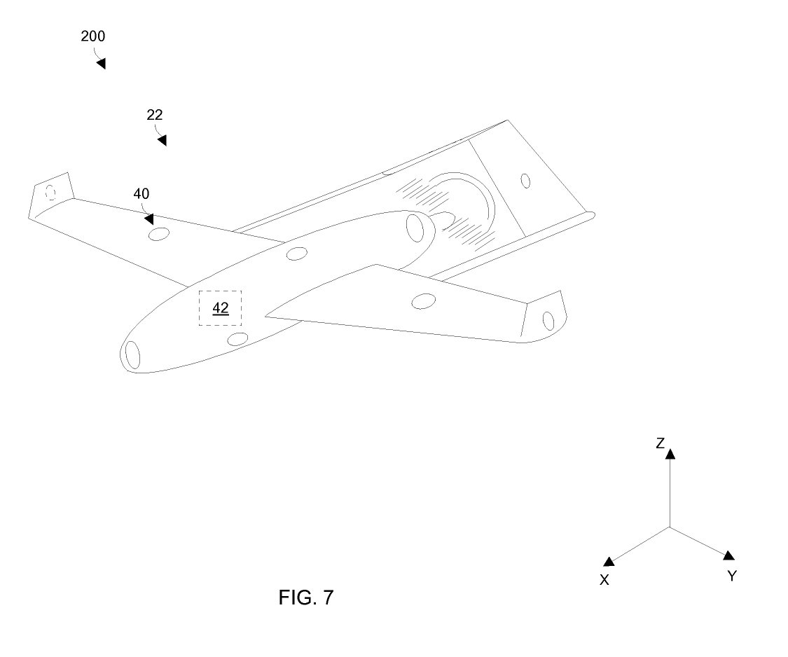

At 156, after the set of electronic signals have been obtained, the human team uses the set of electronic signals to display the images of the environment 88 from the perspective of the UAV. For example, a composite image or moving video can be played which shows separate images collected from the individual cameras stitched together in a mosaic to illustrate a panoramic view. In some arrangements, various types of image data are available and a user is able to select among the different types of image data, e.g., visual light data, infrared data, LiDAR data, etc. Further details will now be provided with reference to FIG. 7.

FIG. 7 is a perspective view of an alternative vehicle 200 to that of FIG. 1. The vehicle 200 is a propeller driven fixed-wing UAV. Again, the camera system 22 includes cameras 40 which are integrated with portions of the vehicle 200 to prevent creation of fluid drag on the vehicle 200.

Other types of aircraft are suitable for use by the improved techniques described herein (e.g., helicopter-style aircraft, rockets, balloons, gliders, etc.). Moreover, vehicles other than aircraft are suitable for use as well (e.g., land vehicles, water vehicles, space vehicles, etc.).

As described above, improved techniques are directed to providing visibility to a vehicle's environment 88 via a set of cameras 40 which is conformal to the vehicle 20. That is, the vehicle 20 includes a set of vehicle surface portions 24 which defines the shape of the vehicle 20 and it is unnecessary to change the shape of the vehicle 20 to accommodate the set of cameras 40. For example, a fixed-wing aircraft can be formed of fuselage sections, wing sections, a nose section, a tail section, and so on. In such situations, a set of cameras 40 is integrated with the set of vehicle surface portions 24 to avoid causing drag (e.g., each camera 40 is substantially embedded within a respective surface portion 24 of the vehicle). A controller 42 which is coupled to the set of cameras 40 then processes individual camera signals from the cameras 40 and outputs a set of electronic signals providing a set of images of the vehicle's environment from a perspective of the vehicle 20. In some arrangements, the controller 42 provides a full 360 degree view of the environment around the vehicle 20. Accordingly, no human camera aiming or gimbals are required.

While various embodiments of the present disclosure have been particularly shown and described, it will be understood by those skilled in the art that various changes in form and details may be made therein without departing from the spirit and scope of the present disclosure as defined by the appended claims.

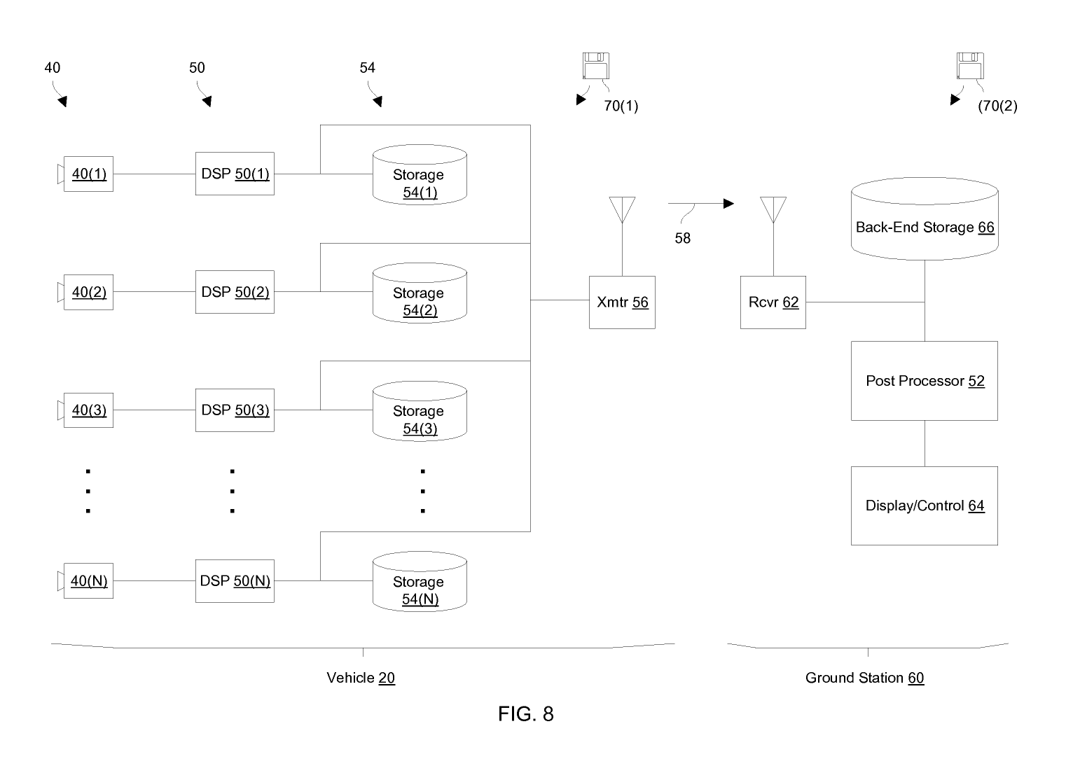

For example, it should be understood that, in certain arrangements, the various components of the camera system 20 are partitioned and distributed in a manner which is different than that of FIG. 2. Along these lines and as shown in FIG. 8, in some arrangements, the vehicle 20 includes cameras 40, DSP units 50, storage 54, and transmitter circuitry 56. Also, the ground station 60 includes receiver circuitry 62, post processor 52, display/control circuitry 64 and back-end storage 66.

In connection with the arrangements of FIG. 8, each signal from a DSP unit 50 is transmitted by the transmitter 56 to the ground station 60 for further processing (i.e., the post processor 52 is situated at the ground station 60). In particular, the receiver 62 at the ground station 60 receives the image data 58 from the vehicle 20, and the image data 58 is saved in the back-end storage 66. Additionally, the post processor 52 processes the image data 58 for display on the display/control 64 and for later access from the back-end storage 66. Moreover, computer program products 70(1), 70(2) can be respectively provided to the circuitry of the vehicle 20 and the circuitry of the ground station 60 to direct such operation.

In other arrangements, each camera signal is transmitted to the ground station 60 for further processing (i.e., the DSP circuitry 50 and the post processor 52 are situated at the ground station 60). In yet other arrangements, back-end storage 66 (i.e., storage in addition to the vehicle storage 54) is located at the ground station 60, and so on.

Additionally, it should be understood that the term UAV was used above to describe various apparatus which are suitable for the disclosed improvements. It should be understood that the improved techniques are applicable to a variety of vehicles including unmanned aircraft (UA) generally, organic air vehicles (OAVs), micro air vehicles (MAVs), unmanned ground vehicles (UGVs), unmanned water vehicles (UWVs), unmanned combat air vehicles (UCAVs), and so on.

Furthermore, the disclosed improvements are suitable for manned vehicles as well. That is, in the context of a manned vehicle, the pilot/driver (or even passenger) is not burdened with holding and aiming a camera. Such modifications and enhancements are intended to belong to various embodiments of the disclosure.

What is claimed is:

1. An aircraft camera system to provide visibility to a vehicle's environment, the vehicle having a set of vehicle surface portions which defines a shape of the vehicle, comprising:
a set of cameras integrated with the set of vehicle surface portions to avoid adding fluid drag force on the vehicle as the vehicle moves within the vehicle's environment; and
a controller coupled to the set of cameras, the controller being constructed and arranged to obtain a set of camera signals from the set of cameras and output a set of electronic signals based on the set of camera signals, the set of electronic signals providing a set of images of the vehicle's environment from a perspective of the vehicle.

2. An aircraft camera system as in claim 1 wherein the set of cameras includes multiple fixed cameras, each fixed camera having a fixed viewing direction to capture an image of the vehicle's environment at a predefined angle from the vehicle.

3. An aircraft camera system as in claim 2 wherein the vehicle is an unmanned aerial vehicle (UAV);
wherein the set of vehicle surface portions defines a shape of the UAV; and
wherein each fixed camera resides at or below the surface of a respective vehicle surface portion of the set of vehicle surface portions.

4. An aircraft camera system as in claim 2 wherein each fixed camera aims in a different direction to capture an image of the vehicle's environment at a different angle from the vehicle; and
wherein the set of electronic signals outputted by the controller defines a multi-directional composite view of the vehicle's environment.

5. An aircraft camera system as in claim 4 wherein the multi-directional composite view of the vehicle's environment is a full 360 degree view from the perspective of the vehicle.

6. An aircraft camera system as in claim 5 wherein the controller is constructed and arranged to perform a set of image knitting operations to generate the full 360 degree view from the perspective of the vehicle.

7. An aircraft camera system as in claim 5 wherein the full 360 degree view from the perspective of the vehicle includes a set of visual light images.

8. An aircraft camera system as in claim 5 wherein the full 360 degree view from the perspective of the vehicle includes a set of infrared images.

9. An aircraft camera system as in claim 5 wherein the full 360 degree view from the perspective of the vehicle includes a set of laser-detected (LiDAR) images.

10. An aircraft camera system as in claim 5 wherein the full 360 degree view from the perspective of the vehicle includes (i) a set of visual light images, (ii) a set of infrared images, and (iii) a set of laser-detected (LiDAR) images.

11. An aircraft camera system as in claim 2 wherein the vehicle is an unmanned aerial vehicle (UAV); wherein the set of vehicle surface portions includes a UAV nose section; and wherein the multiple fixed cameras include a nose section camera which is integrated with the UAV nose section.

12. An aircraft camera system as in claim 11 wherein the set of vehicle surface portions further includes a UAV tail section; and wherein the multiple fixed cameras further include a tail section camera which is integrated with the UAV tail section.

13. An aircraft camera system as in claim 12 wherein the set of vehicle surface portions further includes a UAV belly section; and wherein the multiple fixed cameras further include a belly section camera which is integrated with the UAV belly section.

14. An aircraft camera system as in claim 13 wherein the set of vehicle surface portions further includes a UAV right wing section and a UAV left wing section; and wherein the multiple fixed cameras further include a right wing section camera which is integrated with the UAV right wing section and a left wing section camera which is integrated with the UAV left wing section.

15. An unmanned aerial vehicle (UAV), comprising:
a set of UAV surface portions which defines a shape of the UAV;
a set of cameras integrated with the set of UAV surface portions to avoid adding fluid drag force on the UAV as the UAV moves within an environment; and
a controller coupled to the set of cameras, the controller being constructed and arranged to obtain a set of camera signals from the set of cameras and output a set of electronic signals based on the set of camera signals, the set of electronic signals providing images of the environment from a perspective of the UAV.

16. An unmanned aerial vehicle (UAV) as in claim 15 wherein the set of cameras includes multiple fixed cameras, each fixed camera having a fixed viewing direction to capture an image of the UAV's environment at a predefined angle from the UAV.

17. An unmanned aerial vehicle (UAV) as in claim 16 wherein the set of UAV surface portions defines a shape of the UAV; and
wherein each fixed camera resides at or below the surface of a respective UAV surface portion of the set of UAV surface portions.

18. An unmanned aerial vehicle (UAV) as in claim 16 wherein each fixed camera aims in a different direction to capture an image of the UAV's environment at a different angle from the UAV; and
wherein the set of electronic signals outputted by the controller defines a multi-directional composite view of the UAV's environment.

19. An unmanned aerial vehicle (UAV) as in claim 18 wherein the multi-directional composite view of the UAV's environment is a full 360 degree view from the perspective of the UAV.

20. A method of providing visibility to a vehicle's environment, the method comprising:
deploying an unmanned aerial vehicle (UAV) having (i) a set of UAV surface portions which defines a shape of the UAV, (ii) a set of cameras integrated with the set of UAV surface portions to avoid adding fluid drag force on the UAV as the UAV moves within an environment, and (iii) a controller coupled to the set of cameras, the controller being constructed and arranged to obtain a set of camera signals from the set of cameras and output a set of electronic signals based on the set of camera signals, the set of electronic signals providing images of the environment from a perspective of the UAV;
obtaining the set of electronic signals from the UAV; and
after the set of electronic signals have been obtained, using the set of electronic signals from the UAV to display the images of the environment from the perspective of the UAV.
